(19) United States
(12) Patent Application Publication
(10) Pub. No.: US 2007/0180707 A1
(43) Pub. Date: Aug. 9, 2007

(54) Eyelet for a trimmer head

(76) Inventor: Marcus Nystrom, Norrahammar (SE)

Correspondence Address: PEARNE & GORDON LLP, 1801 EAST 9TH STREET, SUITE 1200, CLEVELAND, OH, 44114-3108, US

(21) Appl. No.: 10/567,478

(22) PCT Filed: Jul. 21, 2004
(86) PCT No.: PCT/SE04/01145

§ 371 Date: Jun. 26, 2006

(30) Foreign Application Priority Data
Aug. 7, 2003 (SE) 0302176-3

(51) Int. Cl. B26B 9/00

(52) U.S. Cl. 30/347

(57) ABSTRACT

Trimmer head comprising at lease two eyelets (17) and a bobbin (10) provided with at least two sections (11, 12) for storing of one cutting filaments (13, 14) in each section. The eyelet (17) is placed in a housing surrounding the bobbin (10) and is provided with an opening for the cutting filament (13, 14). The opening is extending in axial direction of the trimmer head so that the opening provides access to all sections (11, 12) for storing of cutting filament (13, 14). One side of the opening has groove shaped so that the cutting filament (13, 14) is placed in the groove when the trimmer head rotates no matter of which section (11, 12) of the bobbin (10) the filament (13, 14) is stored in.

The claimed invention relates to an eyelet for a trimmer head comprising a bobbin with two sections for storing of one cutting filaments in each section, said eyelet is placed in a housing surrounding the bobbin.

Trimmer heads are used for different types of portable grass and vegetation trimmers. The trimmer head is fastened to a drive shaft and rotates at a high speed so that the cutting filament extend in radial direction outwards from the trimmer head. The cutting filament is used as a knife to cut the vegetation. A trimmer head is provided with at least one cutting filament extending from the circumference of the trimmer head. Most trimmer heads, however, are provided with two cutting filaments placed at opposite sides of the circumference of the trimmer head but at the same line transverse to the axial direction of the trimmer head so that they rotate in the same plane around the trimmer head.

The cutting filament is normally made of some kind of fiber or plastic material. When the trimmer is used will the length of the cutting filament decrease because of the wear from the vegetation that are cut. The cutting filament must then be replaced to make the trimmer work as intended. There are different solutions to solve this problem. The most frequently used solution includes a bobbin placed inside a trimmer head housing. The cutting filaments are stored on the bobbin and sections of new cutting filament are unwinded off the bobbin to replace the used cutting filament.

The cutting filaments are stored in different sections on the bobbin separated from each other to avoid that they attach to each other unintentionally. In order to make it easy for the operator to reload the bobbin with cutting filament is the bobbin kept in the trimmer head during the reloading. One end of the new line of cutting filament is put through the eyelet where the filament that will be used exits the trimmer head housing. The end of the new line of cutting filament is put further in so that is enters an opening in the bobbin placed in the section of the bobbin where the filament is supposed to be stored. The bobbin is then rotated so that the end of the cutting filament is locked in the opening in the bobbin and the cutting filament winded on the bobbin when it is rotated further.

The known eyelets and bobbins are unfortunately complicated since they have to make it possible for the operator to store each cutting filament in the right section for that particular cutting filament and still have the opening for the cutting filament placed at the same line around the trimmer head housing to make sure that the cutting filament will rotate in the same plane.

The claimed invention aims to make the eyelet and the bobbin less complicated and make it easier for the operator to reload the bobbin with cutting filament.

The claimed eyelet is provided with one opening for the line of cutting filament. The opening is extending in the axial direction of the trimmer head so that the opening provides access to all sections where cutting filaments are stored on the bobbin. The opening is V-shaped and placed so that the tip end of the V is located at the position where the line of cutting filament is supposed to exit the trimmer head housing during use of the trimmer head. The V-shaped opening is turned 90° in relation to the axial direction of the trimmer head. The opening is turned so that the tip end is pointing in the same direction as the line is extending inside the trimmer head housing when it has entered through the eyelet.

The claimed eyelet makes it possible for the operator to refill the bobbin in an easy way since the eyelet provides access to each of the sections on the bobbin and the openings to the locking devices for lines of cutting filament on the bobbin.

When the trimmer head is used and the trimmer head is rotating in the intended direction will the shape of the sides of the opening in combination with the forces generated by the rotation of the trimmer head force the line of cutting filament to a position in the tip end of the opening no matter of which section of the bobbin the cutting filament is stored in.

The V-shaped opening is one embodiment of the claimed invention but the opening may also have different shapes as long as one part of it provides access to the different sections on the bobbin for storing lines of cutting filament and the sides of the opening are shaped so that they in combination with the forces generated by the rotation will guide the line of cutting filament into the working position in the opening.

Only one cutting filament extends through each eyelet in the trimmer head housing. Trimmer heads for more than two cutting filaments are provided with one eyelet for every cutting filament and there is only one cutting filament in each section of the bobbin. The claimed eyelet is also easy to manufacture.

Two embodiments of the claimed invention are illustrated in the drawings

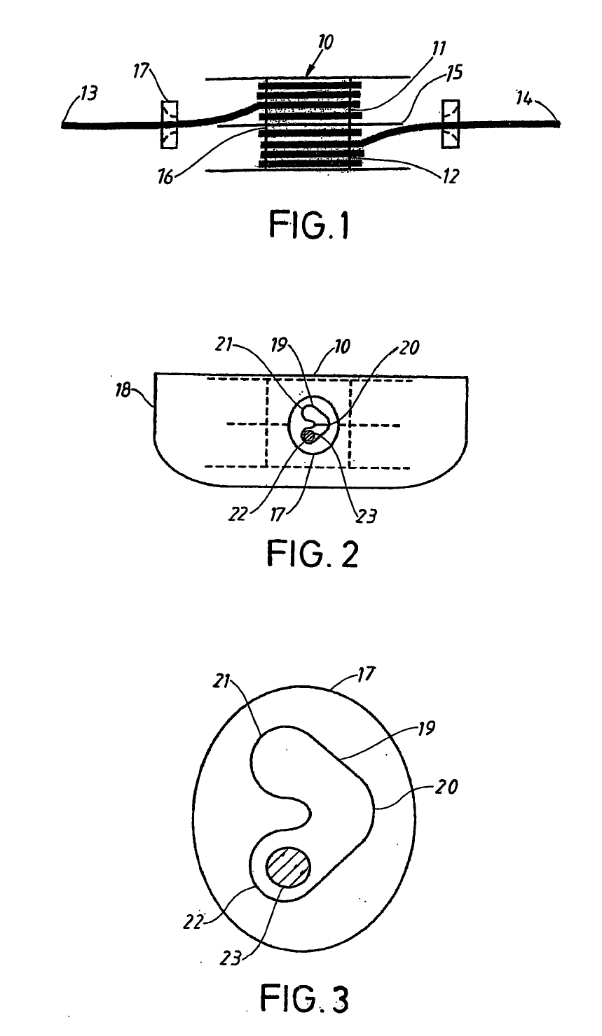

FIG. 1. Illustrates a bobbin with two lines of cutting filament stored in separate sections on the bobbin.

FIG. 2. Illustrates the lower part of the trimmer head housing and an eyelet for a cutting filament.

FIG. 3. Illustrates an eyelet and the position of the cutting filament when the lower section of the bobbin is reloaded with cutting filament.

In FIG. 1 is a bobbin 10 provided with a first and a second section 11 and 12 for storing of a first and a second line of cutting filament 13 and 14 illustrated. The first line of cutting filament 13 is stored in the first section 11 of the bobbin 10 and the second line 14 in the second section 12 of the bobbin 10. A wall 15 extending in radial direction from a cylindrical section 16 that the lines of cutting filament are winded on separates the two sections 11 and 12. Each line of cutting filament is passing through an eyelet 17 secured in a not illustrated trimmer head housing that surrounds the bobbin 10 and the stored cutting filament. The top section of the trimmer head is connected to the drive shaft in the end a tube on the tool.

FIG. 2 illustrates a lower part 18 of the trimmer head housing. At least two eyelets 17 are secured in the lower part 18 of the trimmer head housing and positioned so that the cutting filaments 13 and 14 will rotate in the same plane around the trimmer head. The eyelets 17 are placed symmetrically around the circumference of the trimmer head housing.

The eyelet 17 is in this embodiment provided with an opening 19 shaped like a V with a tip 20 in one end and a first and a second end 21 and 22 separated from each other in the other end. The V-shaped opening 19 is turned 90° in relation to the axial direction of the trimmer head and placed so that the tip 20 of the opening 19 is located above the wall 15 that separates the two sections 11 and 12 on the bobbin 10. The first end 21 of the opening 19 is positioned outside the first section 11 of the bobbin and the second end 22 is placed over the other section of the bobbin 10. The shape of the opening 19 provides access to both sections on the bobbin 10 via the first 21 and the second end 22 that extend in diagonal direction from the tip 20 of the V-shaped opening 19. A cross section 23 of a cutting filament is positioned in the second end 22 of the opening 19. The filament is stored in the second section 12 on the bobbin 10.

The opening 19 is turned so that the tip end 20 is pointing in the same direction as the lines of cutting filament 13 and 14 extends in inside the trimmer head housing when it has entered through the eyelet.

When the cutting filament in the trimmer head is refilled is one end of the line put through the opening 19 close to the first end 21 if the cutting filament is supposed to be stored in the first section 11 on the bobbin 10 and the second end 22 if it is supposed to be stored in the second section 12 and locked in a not illustrated locking device in the cylindrical section 16 of the bobbin 10. The operator then rotates the bobbin 10 by hand so that the line of cutting filament is winded on the cylindrical section 16 in the selected section of the bobbin 10.

When the trimmer head rotates at high speed in the intended direction will the lines of cutting filament because of the shape of the opening 19 and the forces generated by the rotation be forced into a position where it rest towards the inside of the tip end 20 of the V-shaped opening 19 no matter of which section of the bobbin 10 the line is stored in.

One embodiment of the opening 19 is illustrated in the drawings but the claimed invention will work with more than two lines of cutting filament as long as the opening provides access to the different sections for cutting filaments inside the trimmer head housing, and there is a groove or a recess that the cutting filament will be lead to when the trimmer head rotates in the direction that the trimmer head is designed for.

1. Trimmer head comprising at least two eyelets (17) and a bobbin (10) with at least two sections (11,12) for storing of one cutting filament (13,14) in each section, said eyelet (17) is placed in a housing surrounding the bobbin (10), characterized in that the eyelet (17) is provided with an opening (19) for the cutting filament, said opening (19) is extending in axial direction of the trimmer head so that the opening (19) provides access to all sections (11,12) for storing of cutting filaments (13,14) and that one side of the opening (19) has a groove shaped so that the cutting filament (13,14) is placed in the groove when the trimmer head rotates in the intended direction so that the cutting filament is placed in the groove by the forces generated by the rotation no matter of which section (11,12) of the bobbin (10) the filament (13,14) is stored in.

2. Trimmer head according to claim 1, characterized in that the eyelets (17) are placed around the same axial position on the trimmer head housing so that the cutting filaments (13,14) will rotate in the same plane around the trimmer head.

3. Trimmer head according to claim 1, characterized in that the different sections(11, 12) of the bobbin (10) is separated by at least fragments of a wall (14) extending in radial direction from a cylindrical section (16) in the centre of the bobbin (10).

4. Trimmer head according to claim 3, characterized in that the cylindrical section (16) is provided with a locking device that secures one end of the cutting filaments to the bobbin (10) in each of the different sections on the bobbin (10) for storing of one line of cutting filament in each section.

5. Trimmer head according to claim 1, characterized in that the number of eyelets (17) at least is the same as the number of cutting filaments in the trimmer head.

6. Trimmer head according to claim 5, characterized in that the trimmer head comprises two eyelets (17) and two cutting filaments (13,14).

7. Trimmer head according to claim 1, characterized in that the opening (19) in the eyelet (17) is V-shaped with a tip (20) in one end and a first (21) and a second end (22) separated from each other in the other end, said tip (20) of the V-shaped opening (19) is coinciding with the groove so that the cutting filament (13,14) is placed in the tip (20) when the trimmer head is rotating in the intended direction 8. Trimmer head according to claim 7, characterized in that the bobbin (10) comprises a first (11) and a second (12) section for storing of cutting filament.

9. Trimmer head according to claim 8, characterized in that the first (21) end of the opening (19) provides access to the first section (11) on the bobbin (10) and the second end (22) of the opening (19) to the second section (12) on the bobbin (10).

10. Trimmer head according to claim 7, characterized in that the V-shaped opening is rotated 90 in relation to the axial direction of the trimmer head, said tip (20) is pointing in the same direction as the cutting filament is extending in when it has entered the trimmer head housing through the eyelet (17).

11. Trimmer head according to claim 1, characterized in that the eyelet is made of a material that is resistant to wear.
